(19) United States
(12) Patent Application Publication
(10) Pub. No.: US 2014/0191058 A1
(43) Pub. Date: Jul. 10, 2014

(54) Method for the expulsion of a plant protection composition and spray gun

(71) Applicants: Claude Taranta, Stutensee (DE); Peter Welter, Mannheim (DE); Gunter Niesar, Neuhofen (DE); Marc Nolte, Mannheim (DE); Antonio Zarco Montero, Sevilla (ES); Jose Antonio Torres Morato, Sevilla (ES); Steffen Henkes, Boehl-Iggelheim (DE)

(72) Inventors: Claude Taranta, Stutensee (DE); Peter Welter, Mannheim (DE); Gunter Niesar, Neuhofen (DE); Marc Nolte, Mannheim (DE); Antonio Zarco Montero, Sevilla (ES); Jose Antonio Torres Morato, Sevilla (ES); Steffen Henkes, Boehl-Iggelheim (DE)

(73) Assignee: BASF SE, Ludwigshafen (DE)

(21) Appl. No.: 14/240,506

(22) PCT Filed: Aug. 23, 2012
(86) PCT No.: PCT/EP2012/066385

§ 371 Date: Feb. 24, 2014

Related U.S. Application Data
(60) Provisional application No. 61/527,628, filed on Aug. 26, 2011.

(30) Foreign Application Priority Data
Aug. 26, 2011 (EP) 11179034.1

(51) Int. Cl. A01M 7/00

(52) U.S. Cl. CPC A01M 7/0046
USPC 239/8; 239/373

(57) ABSTRACT

The invention relates to a method for ejecting a pesticide by means of a fluid chamber 3, which communicates via an electrically controlled fluid valve 48 having a spout 22. The method comprises the following steps: determining a pressure and a duration of a time interval for ejecting the pesticide, filling the pesticide into the fluid chamber 3, applying a defined pressure on the pesticide in the fluid chamber 3 and opening the fluid valve 48 by means of an electric control signal for a specific, previously determined time interval and closing the fluid valve 48 after the time interval has expired, so that a defined volume or a defined weight of the pesticide is ejected by the spout 22. The invention further relates to a spray gun for carrying out the method and to the use of said spray gun for ejecting liquid, in particular gel-like, pesticide.

The present invention relates to a method for the expulsion of a plant protection composition. In the method, the plant protection composition is filled into a fluid chamber. Subsequently, a pressure is exerted on the plant protection composition located in the fluid chamber and the plant protection composition is expelled via a spray orifice. Furthermore, the invention relates to a spray gun for the expulsion of a fluid, in particular a plant protection composition. The spray gun comprises a fluid chamber and a spray orifice which communicates with the fluid chamber. Furthermore, the spray gun has a pressure device which is coupled to the fluid chamber and by means of which a pressure can be exerted on the fluid located in the fluid chamber.

It is known to expel liquids by means of what is known as a spray bottle. In this case, a pumping mechanism acts directly on the liquid which is expelled through a nozzle. Furthermore, in spray devices, it is known to use a pumping mechanism to increase the air pressure in a chamber which accommodates the water to be expelled. When a trigger is then actuated, the water located in the chamber is sprayed outward through a nozzle on account of the compressed air in the chamber.

EP 0 462 749 B1 discloses a spray gun which is actuated by means of a hand lever. The spray gun has a connection for a liquid supply, via which connection pressurized liquids are supplied to the spray gun. At the outlet end of the spray gun, an outlet nozzle is provided for expelling liquid in a particular spray pattern. Provided between the connection for the liquid supply and the outlet nozzle is a control valve which can be opened by means of a trigger.

EP 1 136 135 B1 describes a fluid pump dispenser having a piston mechanism. In this pump dispenser, the formation of droplets or drops of the product at the outlet orifice is avoided in that the product is drawn into the pump chamber at the start of each piston return stroke.

DE 196 12 524 A1 describes a spray gun which is designed particularly for the expulsion of medium- to high-viscosity liquids, such as, for example, pasty adhesives. The substance to be applied is spread in particular over the surface of a sheet-like structure. The spray gun has a substance supply connection piece and a substance outflow connection piece. Arranged between these is a piston chamber in which a piston can be moved back and forth. The piston is coupled to a switching lever. By the switching lever being actuated, the throughflow through the piston chamber can be closed and opened as a result of the movement of the piston. Provided at the switching lever is a sensor switch which is in the form of an inductive proximity switch and switches off substance transport when the switching lever approaches in a stipulated proximity state. In this case, the propulsive pressure of substance transport is reduced before the closure of substance transport takes place. This is intended to prevent material from continuing to flow.

Furthermore, spray guns in which a liquid is atomized into small drops with the aid of a pressure difference are known. For example, the substance to be expelled can be sucked out of a container with the aid of a Venturi tube and then atomized. Spray guns of this type are used, for example, for the spraying of paint. In this case, it is also known to put the paint under pressure by means of a pump and to press it through a nozzle such that the paint is finely atomized.

Finally, U.S. Pat. No. 5,441,180 discloses a spray gun which is designed in particular for the expulsion of plant protection compositions. This spray gun comprises a reservoir for the plant protection composition to be expelled. Furthermore, the spray gun comprises a pivotable trigger by means of which a piston can be moved. As a result of the movement of the piston, the volume in a chamber in which the plant protection composition to be expelled is located is reduced, so that the plant protection composition is expelled. When the trigger is pivoted back again, the piston is moved in the opposite direction, so that the volume of the chamber increases. This generates a negative pressure which sucks the plant protection composition back out of the expulsion orifice.

Plant protection compositions are usually applied in the form of liquid active substance preparations. These are prepared, as a rule, by the dilution of commercially customary active substance concentrates, such as, for example, suspension concentrates (SC), oil dispersions (OD), capsule dispersions (CS), emulsifiable concentrates (EC), dispersible concentrates (DC), emulsions (EW, EO), suspoemulsion concentrates (SE), solution concentrates (SL), water-dispersible and water-soluble powders (WP and SP), and water-soluble and water-dispersible granules (WG, SG) with or in water. In addition, use is also made of products in the form of active substance solutions, which contain the active substance in a concentration suitable for application, what are known as ULVs. Furthermore, in order to combat arthropodic pests, use is frequently made of active substance-containing gels, which, before being applied, are optionally diluted with water to the desired application concentration. Therefore, here and in the following text, the term “plant protection composition” is used both for liquid active substance formulations, including active substance-containing gel formulations, having an active substance concentration suitable for application, and for liquid active substance preparations, including diluted gel formulations, which are obtainable by the dilution of active substance concentrates.

When plant protection compositions are expelled or sprayed by means of a spray gun, it is particularly important that the spray gun can be handled safely and easily. The spray gun should be suitable for mobile use, that is to say it should be capable of being carried easily by a person. Furthermore, it is particularly important that the expelled fluid, that is to say the plant protection composition, can be metered very accurately. Finally, the plant protection composition should be capable of being applied precisely to a desired area from a specific distance by means of the spray gun. In this case, it should be ensured that, during the expulsion operation, no plant protection composition can pass into regions which are not intended to come into contact with the plant protection composition. In particular, it should be ensured that there is no possibility of the user coming into contact with the plant protection composition. Moreover, dripping at the end of the expulsion operation should be avoided. The spray gun should, in particular, also be suitable for the application of active substance-containing gels, for example active substance-containing gels for combating arthropodic pests, and should allow targeted application, for example in the form of spots or strips/strands. Moreover, the spray gun should be insensitive to inhomogeneities of the liquid plant protection composition, such as may occur, for example, during the preparation of the active substance preparation used for application, when the commercially available active substance concentrates are diluted with or in water to the concentration desired for application.

It is the object of the present invention to provide a method and a spray gun of the type initially mentioned, with which it is possible to achieve very accurate metering of the expelled fluid. Furthermore, an outflow of the fluid after the conclusion of the expulsion operation, that is to say a dripping of fluid, is to be prevented.

According to the invention, this object is achieved by a method having the features of claim 1 and a spray gun having the features of claim 9. Advantageous refinements and developments can be gathered from the dependent claims.

In the method according to the invention, the plant protection composition is expelled by means of a fluid chamber which communicates with the spray orifice via an electrically activatable fluid valve. In the method, a pressure and a length of a time interval for the expulsion of the plant protection composition are set. Subsequently, the plant protection composition is filled into the fluid chamber. The previously set pressure is exerted on the plant protection composition located in the fluid chamber. Finally, the fluid valve is opened for the previously set time interval by means of an electric control signal and is closed after the end of the time interval so that a defined volume or a defined weight of the plant protection composition is expelled through the spray orifice. By way of the electric activation of the fluid valve, it is possible to control the expulsion time very precisely. As a result, the quantity of the plant protection composition which is expelled during an expulsion operation can be metered very accurately.

In the method according to the invention, in particular the pressure exerted on the plant protection composition located in the fluid chamber is kept constant during the time interval in which the fluid valve is open. Since the quantity of plant protection composition that is expelled is not only dependent on the length of time that the fluid valve is open but is also dependent on the pressure which is exerted on the plant protection composition, the quantity expelled can be set accurately in a simple manner. Specifically, it is not necessary to take into consideration a variable pressure profile during the expulsion operation.

According to one refinement of the method according to the invention, the pressure exerted on the plant protection composition located in the fluid chamber is generated by means of a pressurized gas or a pump. The pressurized gas can be provided for example from a gas cylinder which contains a large quantity of highly pressurized gas, e.g. air. Furthermore, the pressurized gas can be generated by a compressor. As a result, a constant pressure for the expulsion operation can be provided in a simple and cost-effective manner.

According to one refinement of the method according to the invention, the distance between the fluid valve and the spray orifice is less than 50 cm, in particular less than 10 cm and advantageously less than 2 cm. Furthermore, according to one refinement of the method according to the invention, the fluid volume located between the spray orifice and the fluid valve is less than 14 cm³, preferably less than 2.8 cm³, further preferably less than 1.4 cm³ and in particular less than 0.57 cm³. Particularly preferably, the fluid valve is arranged directly at the spray orifice.

In the method according to the invention, in particular a plant protection composition in the form of a fluid (liquid) is expelled and consequently applied. Fluids suitable for application have as a rule a dynamic viscosity in the range of from 0.5 to 1000 mPa·s, frequently from 0.8 to 500 mPa·s (determined by Brookfield's rotational viscometry to DIN 53019 (ISO 3219) at 25° C. and with a shear gradient of 100 s⁻¹). Suitable fluids may be Newtonian liquids or non-Newtonian liquid, the latter preferably being shear-thinning, that is to say viscoelastic or pseudoplastic non-Newtonian fluids.

According to one embodiment of the method according to the invention, low-viscosity fluids are expelled, that is to say in particular liquids having a viscosity of no more than 50 mPa·s, in particular no more than 30 mPa·s, e.g. from 0.5 to 50 mPa·s, in particular from 0.8 to 20 mPa·s (determined by Brookfield's rotational viscometry to DIN 53019 (ISO 3219) at 25° C. and with a shear gradient of 100 s⁻¹). These include both organic liquids, in particular solutions of plant protection active substances, in organic solvents, and also aqueous liquids, for example aqueous active substance solutions, but also emulsions, suspoemulsions and suspensions, in which the plant protection active substance is present in dispersed form in a coherent aqueous phase.

According to a further refinement of the method according to the invention, the plant protection composition expelled is a gel-like fluid. Unlike low-viscosity fluids, gel-like fluids have an increased viscosity. As a rule, such gel-like fluids are viscoelastic and as a rule have at 25° C. a zero shear viscosity η0 of at least 100 mPa·s and in particular at least 200 mPa·s. However, the dynamic viscosity of the gel-like fluid will not as a rule exceed a value of 1000 mPa·s, in particular 500 mPa·s and especially 300 mPa·s (determined by Brookfield's rotational viscometry to DIN 53019 (ISO 3219) at 25° C. and with a shear gradient of 100 s⁻¹) and lies in particular in the range of from 30 to 1000 mPa·s, frequently in the range of from 30 to 800 mPa·s and in particular in the range of from 50 to 500 mPa·s. Preferably, at 25° C. the limit value of the viscosity in the case of an infinite shear gradient η_{∞} is no more than 300 mPa·s and in particular no more than 250 mPa·s. The gel-like liquid may be a gel formulation which contains the active substance in the concentration required for application. In particular, it is a liquid which is obtained by dilution of a gel formulation to the concentration required for application.

The rheological properties of the fluid or the formulation of the fluid are selected in particular such that they are temperature independent or at least scarcely temperature dependent. Preferably, the rheological properties of the fluid or the formulation of the fluid change within a temperature range of from 15° C. to 35° C. only such that the quantity expelled per unit time at a given pressure at a particular nozzle or spray orifice fluctuates only in a range of +/−10%, in particular in a range of +/−5%.

According to a development of the method according to the invention, the length of the time interval is set by a previously carried out calibration. In the calibration, the dependence of the expelled volume or weight of a plant protection composition of a particular viscosity on the exerted pressure and the length of the time interval is determined. In this way, the parameters for the expulsion operation are set very precisely beforehand for a particular plant protection composition. Before the fluid valve is opened, a defined pressure, which was set during the previously carried out calibration, is generated. If a plant protection composition of known viscosity is now filled into the fluid chamber, it is possible to determine very accurately from the previously carried out calibration the length of the time interval in order to expel a desired volume or weight of the plant protection composition. For this previously defined time interval, in the case of the method according to the invention, the fluid valve is opened and the plant protection composition is expelled through the spray orifice. This achieves very accurate metering of the expelled volume or weight of the plant protection composition.

The spray gun according to the invention is distinguished in that an electrically activatable fluid valve for opening and closing the passage from the fluid chamber to the spray orifice is arranged at the spray orifice. The fluid valve is data-coupled to an electric control device by way of which an electric control signal for opening the fluid valve for a particular previously defined time interval and for closing the fluid valve after the end of the time interval can be generated so that a defined volume or a defined weight of the fluid is expelled via the spray orifice.

The spray gun according to the invention is suitable in particular for carrying out the method according to the invention. Therefore, it also has the same advantages. By means of the spray gun according to the invention, in particular the expelled volume of fluid or the expelled weight of fluid can be set very precisely.

A spray gun is understood within the meaning of the invention to be an appliance by means of which a fluid can be expelled, squirted, sprayed or atomized through an orifice. However, upon outflow, a fluid jet, in particular, can be generated by the spray gun according to the invention.

According to one refinement of the spray gun according to the invention, the control device comprises a memory for storing a previously set pressure and a previously set length of the time interval. During the spraying operation, the control device then controls the fluid valve and the pressure device such that the previously stored pressure is exerted on the fluid during the spraying operation and the fluid valve is opened precisely for the stored length of the time interval.

According to another refinement of the spray gun according to the invention, the previously set pressure is not stored. Instead, an adjustable pressure valve is provided and is permanently set in order that it ensures that a particular pressure is always exerted on the plant protection composition in the fluid chamber.

According to one refinement of the spray gun according to the invention, the pressure device comprises a pump, by means of which the pressure can be exerted on the fluid located in the fluid chamber. This refinement has the advantage that it allows a very simple structure of the spray gun.

According to another refinement of the spray gun according to the invention, the pressure device comprises at least one cylinder in which a piston for exerting the pressure on the fluid located in the fluid chamber is mounted movably. In this way, a fluid located in the fluid chamber is pressed out of the cylinder by the movement of the piston in the latter. In such piston metering or piston pumping devices, the problem often arises that at the end of an expulsion operation, at which there is scarcely any more fluid in the fluid chamber, the pressure by which the fluid is expelled drops. The result of this pressure drop is that the expelled fluid jet stalls. The quantity of fluid last expelled no longer has the same expulsion velocity as fluid volumes previously expelled, and therefore the fluid expelled at the end no longer arrives at the target in the same way as the previous fluid volumes. As a result of this, part of the expelled fluid jet falls onto a region between the target area and the spray gun. This is particularly disadvantageous when the spray gun is used for the expulsion of plant protection compositions.

In the spray gun according to the invention, this drop in velocity at the end of fluid expulsion can be prevented, for example, in that at the cylinder there is provided a sensor by way of which a defined position of the piston, in which there is still sufficient fluid in the fluid chamber during the expulsion operation, can be detected. The sensor ensures that the expulsion operations with a filling of the fluid chamber can be carried out such that even during the last expulsion operation the maximum pressure is still exerted by the piston on the remaining fluid in the fluid chamber. Even the quantity of fluid expelled last therefore still has the same expulsion velocity as the fluid volumes previously expelled. In this way, a coherent fluid jet, in which the entire expelled fluid has substantially the same velocity, can be generated and so the entire quantity of fluid expelled during the last expulsion operation reaches the desired target area. In particular, no drop in expulsion velocity occurs at the end of this expulsion operation, thereby ensuring that no regions between the target of the expulsion operation and the spray orifice of the spray gun come into contact with the expelled fluid. This is advantageous particularly when the expelled fluid is a plant protection composition, in particular a liquid, in particular gel-like, high-viscosity plant protection composition.

The defined position of the piston is selected, in particular, such that there is still sufficient fluid in the fluid chamber to ensure that a pressure drop will not occur at the spray orifice at the end of the last expulsion operation. In particular, in this position, the piston has not yet reached its end position in the cylinder in which it butts against a cylinder wall.

In one refinement of the spray gun according to the invention, the defined position of the piston is detected by the sensor by means of a magnetic field generated or varied by the piston. For example, a permanent magnet may be integrated into the piston, said permanent magnet generating a magnetic field, the field strength of which at the location of the sensor depends on the position of the piston. If the field strength of the magnetic field at the sensor exceeds or falls below a specific limit value, the state of the sensor changes. In this case, the limit value for the field strength of the magnetic field is set such that the piston is in this case in the desired position within the cylinder at which there will be no pressure drop during the last expulsion operation.

The sensor comprises, in particular, what is known as a reed contact. In a reed contact, an electrical contact is closed when the field strength of the magnetic field at the location of the sensor exceeds a limit value.

Thus, during the expulsion operation, the sensor of this refinement of the spray gun according to the invention detects the position of the piston by means of a measured value which depends directly on the position of the piston in the cylinder. As a result, the position of the piston in the cylinder can be detected with great accuracy. By way of subsequent electronic processing of the signal generated by the sensor, the last expulsion operation can be detected very precisely, with the result that a pressure drop at the end of the last expulsion operation is avoided.

According to a development of the spray gun according to the invention, the pressure device furthermore comprises a compressed gas line which is coupled to the fluid chamber for exerting the pressure on the fluid located in the fluid chamber. The compressed gas, which is supplied via the compressed gas line, can exert a pressure on the fluid directly. Furthermore, it is possible for the compressed gas to exert a pressure via the movable piston on the fluid which is located in the fluid chamber. To this end, for example in the cylinder there may be formed a pressure chamber at which there is formed a cylinder orifice which is connected to a first connection for a compressed gas line, in particular a compressed air line. Thus, compressed gas can pass into the pressure chamber via the cylinder orifice. When the pressure in the pressure chamber exceeds the pressure in the fluid chamber, the movable piston is pressed in the direction of the fluid chamber in which the fluid is located. Thus, the volume of the pressure chamber is increased and the volume of the fluid chamber reduced, as a result of which the fluid is pressed out through the first cylinder orifice when the fluid valve is opened. At the same time, by the first connection being connected to the compressed gas line, the pressure can be kept constant in the pressure chamber, so that a constant pressure is exerted on the fluid in the fluid chamber by the piston during the expulsion operation.

According to a further refinement of the spray gun according to the invention, said spray gun additionally or alternatively has a compression spring which acts between a stop and the piston. The compression spring can exert on the piston a force in the direction of a reduction in the volume of the fluid chamber. In this case, it is possible to configure the spray gun such that no pressure chamber is formed and the cylinder is not connected to a compressed gas line. In this case, the piston pressure is generated solely by the compression spring. The pressure exerted on the fluid during the filling of the fluid chamber must then optionally exceed the pressure exerted by the compression spring, so that, during the filling of the fluid chamber with the fluid, the compression spring is compressed and the volume of the fluid chamber increases. Moreover, it is possible, however, to provide the compression spring in addition to the pressure chamber. In this case, the compression spring supports the pressure which is exerted on the piston by the compressed gas in the pressure chamber.

Furthermore, the spray gun according to the invention may have a regulating device, by means of which the movement of the piston in the cylinder and therefore the maximum volume of the fluid chamber can be limited. Thus, the fluid volume expelled during the expulsion operations can be set by means of the regulating device.

According to another refinement, the sensor is adjustable in the longitudinal direction of the cylinder. In this case, the expelled fluid volume of a series of fluid expulsions can be set by the position of the sensor being set in relation to the cylinder.

According to a development of the spray gun according to the invention, the latter has a second connection for a fluid reservoir. The fluid reservoir may be integrated into the spray gun. If, however, the fluid reservoir is intended to accommodate relatively large quantities of fluid, the fluid reservoir is provided separately from the spray gun, and so the fluid is supplied to the spray gun via the second connection. This second connection may be connected to a further cylinder orifice, via which fluid can be supplied to the fluid chamber. However, it is also possible for the second connection to be connected to the cylinder orifice via which the fluid is pressed to the spray orifice, and so the fluid can be conveyed into the fluid chamber via the second connection and the cylinder orifice. Thus, the fluid then flows through the cylinder orifice both into the fluid chamber of the cylinder and out of this fluid chamber.

In this case, it is possible, furthermore, to design the fluid valve as a first 3/2-way valve, in which, in a first position, a fluid passage from the cylinder orifice to the spray orifice is provided, and, in a second position, a fluid passage from the second connection to the cylinder orifice is provided.

A 3/2-way valve is understood to be a valve with three connections and two switch positions. The fluid reservoir or the second connection, the spray orifice and the cylinder orifice are connected to the three connections of the valve. In the first position of the valve, a passage from the cylinder orifice to the spray orifice is provided, the passage from the fluid reservoir or the second connection to the cylinder orifice being closed. In the second position of the valve, a fluid passage from the fluid reservoir or the second connection to the cylinder orifice is provided, the passage from the cylinder orifice to the spray orifice being closed. Thus, by means of the first 3/2-way valve, both fluid transport to the spray orifice during the expulsion operation and fluid transport for filling the fluid chamber of the cylinder for the fluid are carried out.

Furthermore, in the spray gun according to the invention, a compressed gas valve configured as a second 3/2-way valve may be arranged between the first connection, via which a compressed gas can be supplied to the spray gun, and the cylinder orifice for introducing the compressed gas. In the first position of this compressed gas valve, a compressed gas passage from the first connection to this cylinder orifice is provided. In the second position of the compressed gas valve, a reduction in the pressure of the compressed gas within the pressure chamber is made possible. For example, in the second position, a compressed gas passage from the cylinder orifice into the open may be provided.

According to a development of the spray gun according to the invention, the fluid reservoir is connected to a device for the provision of compressed gas, in particular compressed air. The device may be, for example, a compressed air tank, a compressor and a hand pump. However, the fluid may also be put under pressure directly, for example by a pump. In addition, the fluid reservoir is connected via a line to the first connection of the compressed gas valve. A connection from the compressed gas valve to the fluid reservoir is thus provided. This connection may be integrated into the spray gun or be formed separately from the spray gun. In the second position of the compressed gas valve, the pressure chamber can thus be acted on with compressed gas. Furthermore, the fluid reservoir is acted on with compressed gas in order to effect fluid transport for filling the fluid chamber of the cylinder.

According to a development of the spray gun according to the invention, the sensor is coupled to the first and the second 3/2-way valve. In this case, the sensor switches the first and the second 3/2-way valve into the second position when the piston has reached or passed the defined position, so that fluid is conveyed by means of the compressed gas from the fluid reservoir into the fluid chamber via the first 3/2-way valve. After the last expulsion operation has been ended, the fluid chamber of the cylinder is thus refilled with fluid automatically via the two 3/2-way valves. Switching of the valves takes place in particular electronically. Preferably, the two valves are changed over simultaneously, or first of all the first 3/2-way valve for the fluid is changed over and shortly thereafter the second 3/2-way valve for the compressed gas.

According to a further refinement of the spray gun according to the invention, the fluid chamber and the spray orifice are connected together via a connecting line. In this case, the fluid valve is arranged adjacent to the spray orifice in the connecting line and in particular is arranged directly at the spray orifice. The distance of the spray orifice from the fluid valve is less than 50 cm, preferably less than 10 cm, further preferably less than 5 cm and in particular less than 2 cm. In this case, the fluid volume located between the spray orifice and the fluid valve is less than 14 cm³, preferably less than 2.8 cm³, further preferably less than 1.4 cm³ and in particular less than 0.57 cm³. The fluid valve is thus positioned as close as possible to the spray orifice. As a result, it is possible to prevent dripping even when viscous or highly viscous fluids are expelled by means of the spray gun. Specifically, it has been found that in this case dripping cannot be prevented by for example a ball valve which is arranged at the spray orifice. However, such dripping can be prevented by the electronically activated fluid valve directly at the spray orifice.

The spray gun according to the invention also has in particular a trigger, for example a manual trigger. An expulsion operation is initiated by this trigger once the fluid chamber has been filled. However, before the control device opens the fluid valve for expelling the fluid following the actuation of the trigger, a check is advantageously carried out as to whether the pressure exerted on the fluid in the fluid chamber corresponds to a pressure which was set during a previously carried out calibration. This pressure is stored in the memory of the control device for each fluid that can be used with the spray gun. The current pressure within the fluid chamber or within the pressure chamber, via which the pressure is exerted on the fluid in the fluid chamber, is detected by means of a pressure sensor which is data-coupled to the control device. Only when the measured pressure lies ideally at the previously stored pressure or in a previously stored pressure range is the fluid valve opened for the previously defined time interval following the actuation of the trigger. The time interval associated with the respective pressure is also stored in the memory of the control device for a fluid of a particular viscosity.

The electrically activatable fluid valve of the spray gun according to the invention is a valve which can receive an electronic control signal which effects the opening and closing of the valve. In order to open and close the valve, the valve can be actuated for example electromagnetically. For example, a particular voltage can be applied to the valve in order to open the valve. This voltage leads to an electromagnetic actuation of the valve, in which the valve is moved into an open state. If the voltage is no longer applied, the valve is automatically closed. Thus, in order to open the fluid valve for the defined time interval, the control device applies a voltage to the fluid valve for this time interval, said voltage keeping the fluid valve in an open state.

The trigger, too, is in particular an electronic trigger, on the actuation of which a control signal is transmitted to the control device. Finally, the further fluid valves for filling the fluid chamber and the compressed gas valve can also be electrically activated and electromagnetically actuated. On account of the electronic control of the valves and the electronic trigger for the spray gun, it is possible to design the mechanical structure of the spray gun very simply. A reduction in the weight of the spray gun can thereby be achieved, this being advantageous particularly in the case of mobile use of the spray gun. What is achieved by the electronic control of the valves is that the fluid expulsion can be controlled very accurately, this being important particularly when plant protection compositions are being expelled.

In an alternative refinement of the spray gun according to the invention, a first and a second fluid chamber are formed in the cylinder. In the first fluid chamber, at least one first cylinder orifice is formed. In the second fluid chamber, at least one second cylinder orifice is formed. In this alternative refinement, the fluid accommodated in the first fluid chamber can be pressed out by fluid being pressed under pressure into the second fluid chamber, as a result of which a force is exerted on the piston in the direction of a reduction in the size of the first fluid chamber. Conversely, the fluid accommodated in the second fluid chamber can be pressed out by fluid being pressed under pressure into the first fluid chamber, as a result of which a force is exerted on the piston in the direction of a reduction in the size of the second fluid chamber. In this refinement of the spray gun according to the invention, the pressure chamber which can be filled with compressed gas has thus been replaced by a fluid chamber. In this case, pressure is exerted on the piston not by a compressed gas, but by the fluid located in the other fluid chamber in each case, so that the fluid is expelled alternately out of the two fluid chambers. The advantage of this refinement is that the intermissions between two series of expulsion operations of the spray gun are very much shorter, since it is no longer necessary to wait until the fluid chamber has filled again in order to start the next series of fluid expulsions. Specifically, the filling of one fluid chamber causes the expulsion of fluid via the other fluid chamber.

According to a development of this refinement of the spray gun according to the invention, a first sensor is provided in the first fluid chamber and a second sensor is provided in the second fluid chamber. As explained above, a defined position of the piston, in which fluid is still located in the respective fluid chamber during the expulsion operation, can be detected by the sensor. The respective fluid valve is closed by means of the sensor when the defined position of the piston has been detected.

According to a development of this refinement of the spray gun according to the invention, the sensors can be adjusted in the longitudinal direction of the cylinder. In this case, the expelled fluid volume of a series of fluid expulsions can be set by the position of the sensors being set in relation to the cylinder.

According to a further alternative refinement of the spray gun according to the invention, said spray gun comprises a first and a second cylinder. A first fluid chamber with a first cylinder orifice is formed in the first cylinder, and a second fluid chamber with a second cylinder orifice is formed in the second cylinder. Furthermore, a first pressure chamber is formed in the first cylinder and a second pressure chamber is formed in the second cylinder, the first and the second pressure chamber communicating with one another and comprising a non-compressible working fluid. The first fluid chamber is separated from the first pressure chamber by a first piston. The second fluid chamber is separated from the second pressure chamber by a second piston, the volume of the first fluid chamber decreasing when the volume of the second fluid chamber increases. Conversely, the volume of the first fluid chamber increases when the volume of the second fluid chamber decreases. According to this refinement, the fluid accommodated in the first fluid chamber can be pressed out by fluid being pressed under pressure into the second fluid chamber, a force being exerted on the second piston and being transmitted to the first piston via the working fluid. Conversely, the fluid accommodated in the second fluid chamber can be pressed out by fluid being pressed under pressure into the first fluid chamber, as a result of which a force is exerted on the first piston and is transmitted to the second piston via the working fluid.

In this refinement, the fluid valve is coupled to the first cylinder orifice and the second cylinder orifice, it being possible to produce a fluid passage to the spray orifice only in each case to one cylinder orifice. Furthermore, the fluid valve can preferably also be shut off completely.

In this further refinement, too, the time interval between two series of expulsion operations can be shortened, since the filling of one fluid chamber causes the expulsion operations of the fluid out of the other fluid chamber.

The spray orifice may be designed such that the fluid is atomized, but preferably a liquid jet is generated. To this end, the spray orifice is preferably surrounded by a spray nozzle which generates a liquid jet when the liquid or aqueous solution passes through, that is to say the liquid or solution is in particular not atomized.

The spray nozzle of the spray gun according to the invention is in particular designed such that a plant protection composition can be expelled by way of the spray gun, said plant protection composition having been described above with regard to the method according to the invention. The spray gun is designed in particular for a liquid plant protection composition, the spray orifice in this case being surrounded by a spray nozzle which generates a liquid jet when the liquid plant protection composition passes through. Furthermore, the spray gun can be designed for a gel-like plant protection composition. In this case the spray nozzle generates a jet when the gel-like plant protection composition passes through. The gel-like plant protection composition can thus be applied in a punctiform manner, that is to say in the form of drops, or in a linear manner, that is to say in the form of strands or strips. Examples of suitable spray nozzles are conical nozzles without a baffle plate, jet nozzles or hole-type nozzles.

Examples of gel formulations which can be applied in optionally diluted form by means of the method according to the invention or the spray gun according to the invention are in particular those gel formulations which are used for combating arthropodic pests.

Gel formulations of this type are known, for example, from WO 2008/031870. As a rule, these gels typically comprise at least one active substance which is active against arthropodic pests, such as insects or arachnids (Arachnida). In addition, these gels typically comprise water, at least one thickener or gel former and optionally one or more attractants and/or feeding stimulants.

The above-described spray guns are suitable in particular for the application of liquids which comprise one or more plant protection active substances in a dissolved or dispersed, that is to say suspended or emulsified form. The active substance concentration in these liquids is typically in the range of from 0.001 to 10 g/l. The use of the spray gun is in this regard not restricted to specific plant protection active substances and is suitable for the application of all active substances which are usually employed in plant protection and are used in the form of liquid application forms, including low-viscosity or gel-like application forms. These include in principle all plant protection active substances from the group of rodenticides, herbicides, herbicide safeners, fungicides, insecticides, acaricides, nematicides, molluscicides, virucides, bactericides, algicides, growth regulators, pheromones, above all sexual pheromones (mating disruptors) and activators and also fertilizers.

The present invention relates, furthermore, to the use of the above-described spray gun for the expulsion of the following liquid products:
Aqueous active substance preparations of active substances, in particular plant protection active substances, which are obtainable by dilution of active substance concentrates with water to the desired application concentration and which comprise one or more of the abovementioned plant protection active substances in dissolved or dispersed form.
Non-aqueous solutions or suspensions of active substances, in particular plant protection active substances, which comprise the active substance in a concentration suitable for application.
Aqueous gel-like liquids which comprise one or more active substances, in particular plant protection active substances, especially from the group of insecticides, acaricides or pheromones, and which, with suitable viscosity, are applied as such or optionally after dilution with water to the desired application concentration, and which comprise one or more of the abovementioned plant protection active substances in dissolved or dispersed form, and also water, at least one thickener or gel former and optionally one or more attractants and/or feeding stimulants.

The spray gun according to the invention can be used in a wide variety of sectors of plant protection, in particular for the treatment of plants, especially of their leaves (foliar application), but also for the treatment of plant materials capable of propagation (seed). The spray gun according to the invention is also suitable for the treatment of inanimate materials, in particular of inanimate organic materials, such as wood, straw, paper, leather, textiles or plastic, or of inanimate inorganic materials, such as glass or metal, which are infected with harmful organisms or are intended to be protected from infection with harmful organisms, such as fungi or insects, with a liquid active substance composition, which contain one or more suitable active substances.

Moreover, such materials can be hung up as bait and be charged or recharged with a suitable formulation by means of the spray gun.

The plant protection composition is in particular not atomized by the spray gun as in conventional application, but is applied to the target area in the form of a compact jet. In this case, application may take place at a single point (spot application) or may cover a strip arising from forward movement. On account of the consistency of the plant protection composition, the quantities applied remain adhering to the target area. The plant protection composition therefore has in particular a gel consistency.

The above-described spray gun is used in particular for the expulsion of plant protection compositions, the rheological properties of which are selected such that they are temperature independent or at least scarcely temperature dependent. Preferably, the rheological properties of the plant protection composition change within a temperature range of from 15° C. to 35° C. only such that the quantity expelled per unit time at a given pressure at a particular nozzle or spray orifice fluctuates only in a range of +/−10%, in particular in a range of +/−5%.

Exemplary embodiments of the spray gun according to the invention are explained in detail in the following text with reference to the drawings, in which:

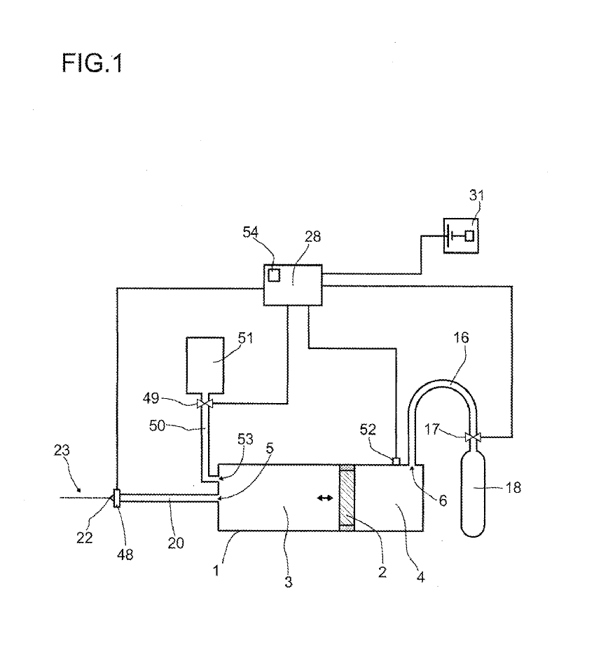

FIG. 1 schematically shows the structure of a first exemplary embodiment of the spray gun according to the invention and the coupling of this spray gun to a fluid reservoir and to a compressed gas container,

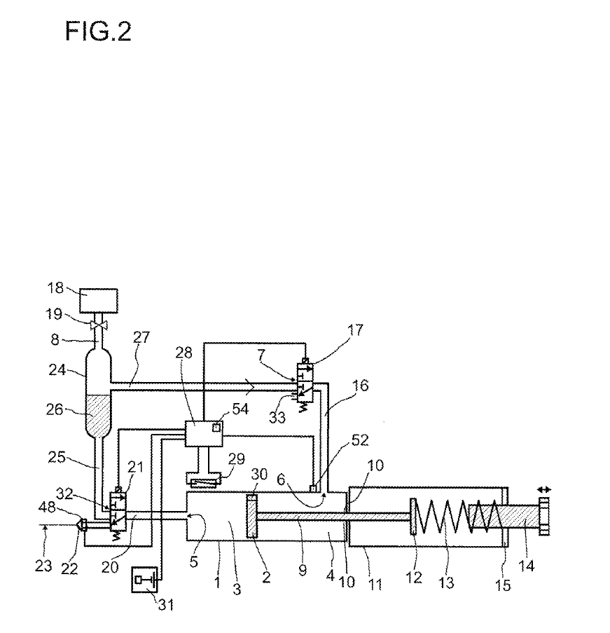

FIG. 2 schematically shows the structure of a second exemplary embodiment of the spray gun according to the invention and the coupling of this spray gun to a fluid reservoir and to a compressed gas container,

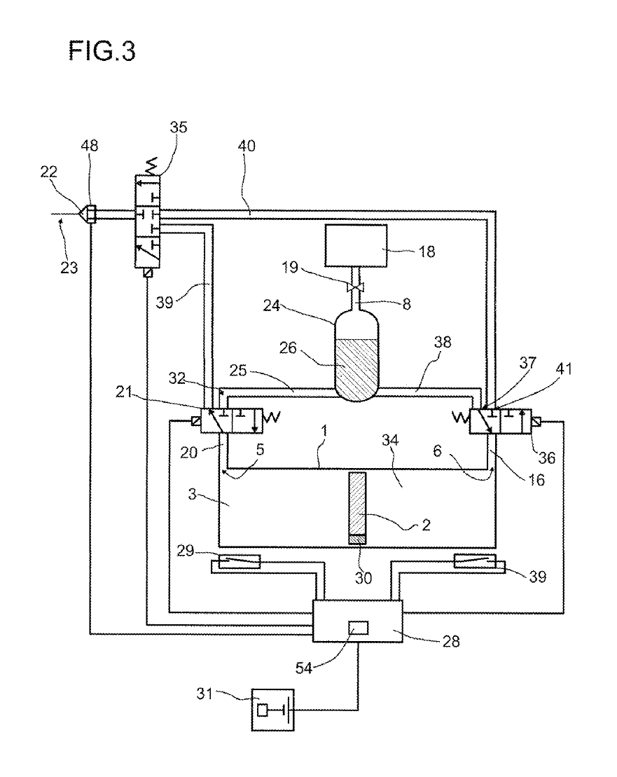

FIG. 3 schematically shows the structure of a third exemplary embodiment of the spray gun according to the invention and the coupling of this spray gun to a fluid reservoir,

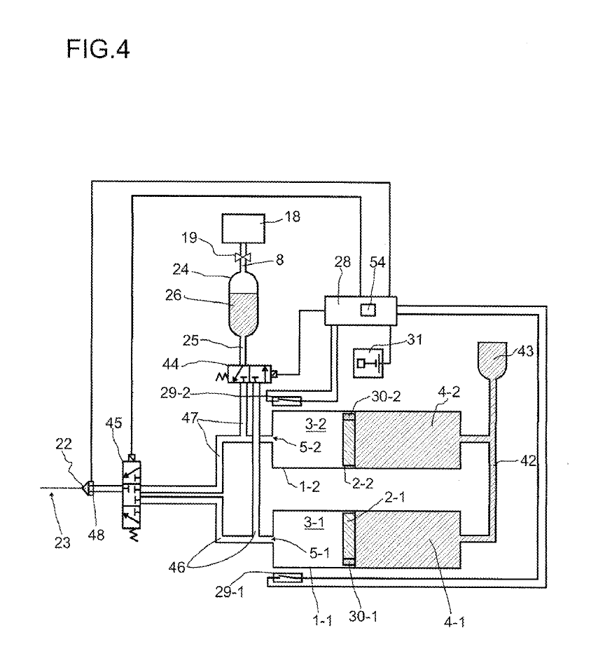

FIG. 4 schematically shows the structure of a fourth exemplary embodiment of the spray gun according to the invention and the coupling of this spray gun to a fluid reservoir,

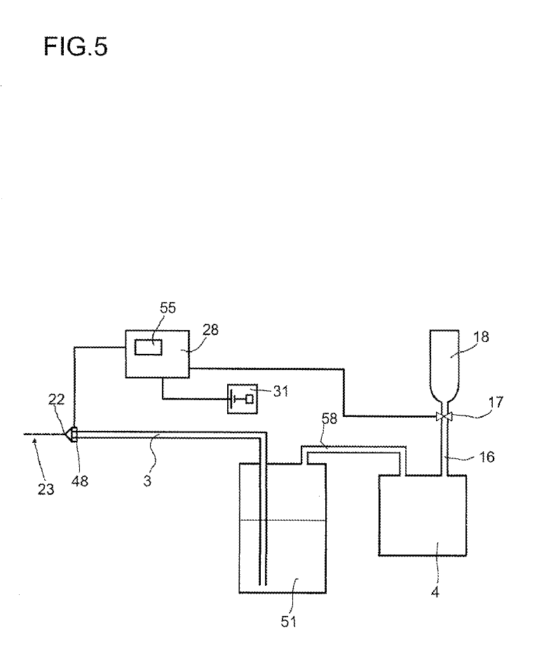

FIG. 5 schematically shows the structure of a fifth exemplary embodiment of the spray gun according to the invention and the coupling of this spray gun to a fluid reservoir,

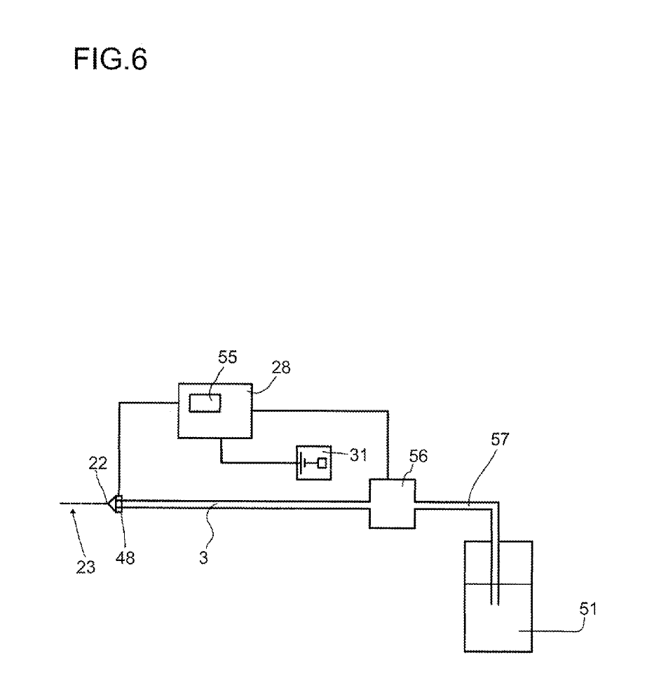

FIG. 6 schematically shows the structure of a sixth exemplary embodiment of the spray gun according to the invention and the coupling of this spray gun to a fluid reservoir, and

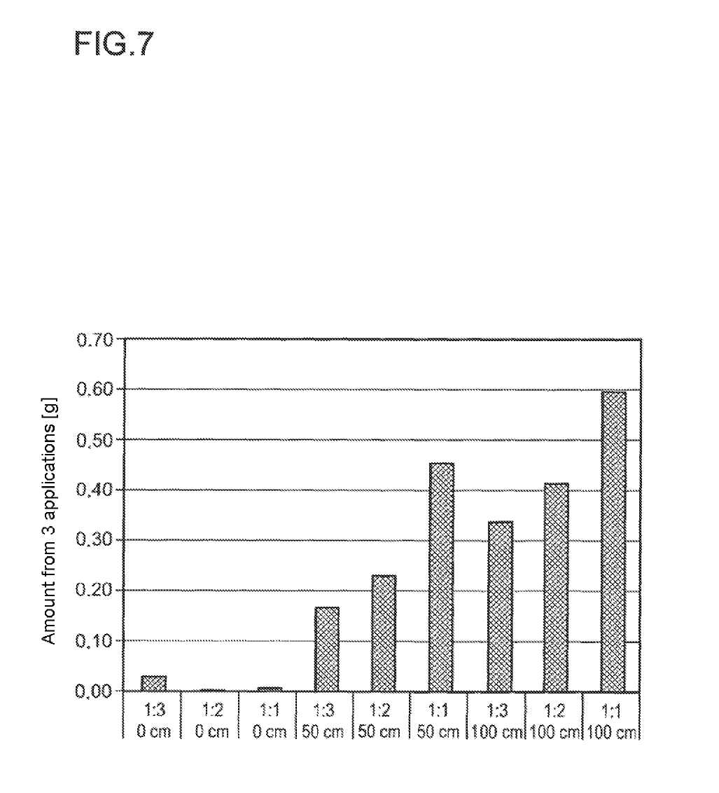

FIG. 7 shows a diagram which illustrates the relationship of the fluid loss depending on the mixing ratio between the active substance and water, i.e. of the viscosity of the fluid, and on the distance between the spray nozzle and the fluid valve.

First of all, the first exemplary embodiment of the spray gun according to the invention is explained with reference to FIG. 1:

The spray gun comprises a cylinder 1, in which there is formed a fluid chamber 3. Formed at one end face of the cylinder 1 is a cylinder orifice 53 for filling the fluid chamber 3 with fluid. The cylinder orifice 53 is connected to a fluid reservoir 51 via a fluid line 50 and a valve 49. The valve 49 is an electrically activatable and electromagnetically actuable valve which is coupled to a control device 28. The control device 28 controls the opening and closing of the valve 49. When the valve 49 is opened by means of the control device 28, fluid flows from the fluid reservoir 51 into the fluid chamber 3 via the line 50. When the fluid chamber 3 is completely full, the valve 49 is closed again by means of the control device 28.

At the end face of the cylinder 1, the latter has a further cylinder orifice 5, which is connected to a spray nozzle 22 via a line 20. Formed in the spray nozzle 22 is a spray orifice. The spray nozzle is designed such that a fluid jet 23 is created when a fluid, for which the spray gun is configured, is pressed under pressure through the spray nozzle 22.

Arranged immediately upstream of the spray nozzle 22, that is to say at that end of the line 20 which is adjacent to the spray nozzle 22, is an electrically activatable fluid valve 48 for opening and closing the passage from the fluid chamber 3 to the spray orifice of the spray nozzle 22. The distance of the spray orifice of the spray nozzle 22 from the fluid valve 48 is in this exemplary embodiment less than 5 cm, preferably less than 2 cm. In order to electrically activate the fluid valve 48, the latter is data-coupled to the control device 28. By means of a control signal which is generated by the control device 28, the fluid valve 48 can be opened for a precisely defined time interval and can be closed again after the end of the time interval.

In order to exert a pressure on a fluid located in the fluid chamber 3, the spray gun comprises a pressure device. In the exemplary embodiment shown in FIG. 1, a piston 2 is mounted movably in the cylinder 1 for this purpose. The cylinder 1 is subdivided in a fluid-tight manner by the piston 2 into the fluid chamber 3 for the fluid to be expelled and a pressure chamber 4. Provided in the pressure chamber 4 is a further cylinder orifice 6, which is connected via a line 16 and a compressed gas valve 17 to a device for providing compressed air, for example a compressed air cylinder 18. The compressed gas valve 17 is also an electrically activatable and electromagnetically actuable valve which is data-coupled to the control device 28. The control device 28 can regulate the pressure in the pressure chamber 4 via the compressed gas valve 17. Provided for this purpose in the pressure chamber 4 is a pressure sensor 52, which detects the pressure in the pressure chamber 4 and transmits a corresponding measured value to the control device 28.

Furthermore, an electronic, manually actuable trigger 31 is provided and is coupled to the control device 28. By actuating the trigger 31, the user can initiate an expulsion operation.

The manner in which the above-described spray gun is calibrated is described in the following text:

First of all, the fluid valve 48 is closed by the control device 28. Then, the valve 49 is opened by the control device 28 and a particular fluid of known viscosity is introduced into the fluid chamber 3 from the fluid reservoir 51. During this operation, the piston 2 is moved optionally in the direction of an increase in the volume of the fluid chamber 3. Once the fluid chamber 3 has been filled with a particular quantity of fluid, the valve 49 is closed by the control device 28. Thereupon, the control device 28 generates a particular pressure in the pressure chamber 4. For this purpose, the control device 28 activates the compressed gas valve 17 and checks the pressure in the pressure chamber 4. Optionally, the compressed gas valve 17 can have an outlet orifice via which compressed air can be let out of the pressure chamber 4 in order to lower the pressure in the pressure chamber 4. This letting out of compressed air via the outlet orifice in the compressed gas valve 17 is also controlled by the control device 28. The pressure generated in the pressure chamber 4 is transmitted to the fluid, which is located in the fluid chamber 3, via the movable piston 2. The pressure is sufficiently large for the operation of expelling the fluid via the spray nozzle 22.

Subsequently, the fluid valve 48 is opened for a particular time interval by means of the control device 28. During this time interval, fluid is expelled from the fluid chamber 3 via the spray nozzle 22. The expelled fluid is collected and the expelled volume and/or the expelled weight are measured. Subsequently, the pressure during the expulsion operation, the viscosity of the expelled fluid, the length of the time interval for which the fluid valve 48 was open, and the volume and/or the weight of the expelled fluid are stored in a memory 54 in the control device 28. Optionally, this operation is repeated at different pressures and time intervals until the desired parameters for the expulsion operation have been set for the fluid having the defined viscosity. These parameters, that is to say the viscosity of the fluid, the pressure during the expulsion operation and the length of the time interval for the expulsion operation are stored as setpoint values in the memory 54 in the control device 28. Moreover, the calibration can be executed before each series of expulsions. In this case, storing in a memory is not necessary. Optionally, the temperature of the fluid during the expulsion operation can additionally be sensed and stored. The calibration can be carried out for fluids of different viscosities.

Thus, a pressure and a length of a time interval for the expulsion of a fluid, for example a plant protection composition, having a particular viscosity are set in advance.

In the following text, an exemplary embodiment of the method according to the invention is described, as is carried out by means of the spray gun described with reference to FIG. 1 following calibration:

As in the calibration operation, the fluid chamber 3 is filled with a particular fluid volume from the fluid reservoir 51. The volume in the fluid chamber 3 is in this case sufficient for a series of expulsion operations. Subsequently, the valve 49 is closed by means of the control device 28. Then, the control device 28 uses the pressure sensor 52 and the compressed gas valve 17 to regulate the pressure of the compressed air in the pressure chamber 4 such that it corresponds to the value which was determined during the previously carried out calibration operation.

The user now manually actuates the trigger 31. The electronic trigger 31 thereupon transmits a corresponding control signal to the control device 28. The control device 28 now checks whether the pressure in the pressure chamber 4 corresponds, optionally with a certain tolerance, to the pressure which is stored in the memory 54 and was set during the calibration. If the measured actual pressure corresponds to the stored setpoint pressure, optionally with a tolerance range being taken into consideration, the control device 28 opens the fluid valve 48 precisely for a time interval, the length of which is stored in the memory 54 in the control device 28 and was set during the calibration. To this end, the control device 28 transmits a corresponding control signal to the fluid valve 48. For example, a voltage is applied to the fluid valve 48 for the length of the time interval. After the end of the time interval, the fluid valve 48 is closed again by means of the control device 28. For example, the applied voltage is set back to zero so that the fluid valve 48 closes again.

During the time interval for which the fluid valve 48 is open, the fluid located in the fluid chamber 3 is expelled as a fluid jet 23 via the spray orifice in the spray nozzle 22. The length of the time interval is for example in a range of from 0.5 second to 6 seconds, in particular in a range of from 1 second to 3 seconds. During this period of time, the control device 28 regulates the pressure in the pressure chamber 4 such that it is constant, that is to say that a constant pressure is exerted via the piston 2 on the fluid in the fluid chamber 3.

In the method according to the invention, a gel-like plant protection composition is expelled. The plant protection composition is viscoelastic and has a dynamic viscosity in a range of from 30 to 1000 mPa·s, frequently in a range of from 30 to 800 mPa·s and in particular in a range of from 50 to 500 mPa·s (determined by Brookfield's rotational viscometry to DIN 53019 (ISO 3219) at 25° C. and with a shear gradient of 100 s⁻¹).

The rheological properties of the formulation of the plant protection composition are selected such that they are temperature independent or at least scarcely temperature dependent. The rheological properties of the formulation of the plant protection composition change within a temperature range of from 15° C. to 35° C. for example only such that the quantity expelled per unit time at a given pressure at a particular spray nozzle 22 fluctuates only in a range of +/−10%, in particular in a range of +/−5%.

A second exemplary embodiment of the spray gun according to the invention is explained in the following text with reference to FIG. 2:

In the second exemplary embodiment, parts which have the same function as in the first exemplary embodiment are designated by the same reference signs. The function of these parts is also the same as in the first exemplary embodiment, and therefore the description of these parts is not repeated in detail.

The spray gun comprises a piston metering or piston pumping device, which has a cylinder 1 and a piston 2 which is mounted movably in the cylinder 1. The cylinder 1 is subdivided in a fluid-tight manner by the piston 2 into a fluid chamber 3 for the fluid to be expelled and a pressure chamber 4. Provided in the fluid chamber 3 is a first cylinder orifice 5, through which the fluid chamber 3 can be filled with fluid and through which, moreover, fluid is pressed out of the fluid chamber 3 during the expulsion operation. In the pressure chamber 4, a second cylinder orifice 6 is formed in the cylinder 1 and is connected to a first connection 7 for a compressed gas line 8, as is explained later.

Furthermore, in the cylinder 1 there is provided an orifice, through which the shank 9 of the piston 2 passes and in which this shank 9 is mounted in a gas-tight manner in a bearing 10. Mounting takes place in this case in such a way that the piston 2 can be moved back and forth in the longitudinal direction of the cylinder 1, so that the volume of the fluid chamber 3 and of the pressure chamber 4 is varied as a result of the movement of the piston 2. Furthermore, seals are provided in the mounting, so that no compressed gas can escape from the pressure chamber 4 through this orifice.

That part of the shank 9 of the piston 2 which passes through the further orifice in the cylinder 1 extends into a further cylinder 11. The rear end of the piston 2 is provided with a plate 12 which indicates the position of the piston 2 to the user. For this purpose, the cylinder 11 is formed in an at least partially transparent manner. In addition, the plate 12 serves for coupling the piston 2 to a compression spring 13 which is coupled at one end to the plate 12 and at the other end to a terminating wall 15 of the cylinder 11. The compression spring 13 exerts on the piston 2 a force which acts in the direction of a reduction in the volume of the fluid chamber 3.

Furthermore, provided at the rear end of the cylinder 11, near the terminating wall 15, is a regulating device which limits the movement of the piston 2 in the direction of an increase in the volume of the fluid chamber 3. The maximum volume of the fluid chamber 3 is thus set by means of the regulating device. In the present exemplary embodiment, the regulating device is in the form of a screw 14 which is received in an internal thread of the terminating wall 15 of the cylinder 11. By the screw 14 being rotated in this internal thread, the length of that portion of the screw 14 which extends into the cylinder 11 can be set. If the piston 2 moves, as is explained later, in the direction of the screw 14 during the filling of the fluid chamber 3 with fluid, this movement of the piston 2 is limited by an abutment of the plate 12 against the screw 14.

In order to press the piston 2 in the direction of the first cylinder orifice 5, that is to say to the left in FIG. 2, the gas pressure in the pressure chamber 4 is increased via the second cylinder orifice 6. In the present exemplary embodiment, compressed air is introduced into the pressure chamber 4 via the line 16. The line 16 is connected to a compressed gas valve 17, the function of which is explained later.

As in the first exemplary embodiment, a pressure sensor 52 is provided in the pressure chamber 4 and is coupled to the control device 28. The air pressure in the pressure chamber 4 is increased until the force exerted on the piston 2 by the compressed air and, optionally, the compression spring 13 in the direction of the first cylinder orifice 5 exceeds the force which is exerted on the piston 2 in the opposite direction by the fluid located in the fluid chamber 3. It is pointed out that this propulsive pressure for the piston 2 may also be exerted only by the compressed gas in the pressure chamber 4, only by the compression spring 13 or both by the compressed gas in the pressure chamber 4 and by the compression spring 13.

The first cylinder orifice 5 is connected via a line 20 and a fluid valve 21 to a spray nozzle 22 which provides a spray orifice. The fluid expelled by the spray gun flows out through the spray orifice in a fluid jet 23. The pressure exerted on the fluid may for example be so high that the emerging fluid jet can be shot onto a target area over a distance of two to three meters. The pressure exerted on the fluid may for example be in a range of from 2 bar to 6 bar.

As in the first exemplary embodiment, an electrically activatable fluid valve 48, which is coupled to the control device 28, is arranged directly at the spray nozzle 22. It can be opened and closed by a control signal from the control device 28.

The fluid to be expelled is conveyed into the fluid chamber 3 as follows:

Provided for a fluid stock 26 is a fluid reservoir 24 which is connected to a connection 32 of the spray gun via a line 25. This connection 32 is coupled to a connection of the fluid valve 21 which is in the form of a 3/2-way valve. The further connections of the 3/2-way valve are connected to the first cylinder orifice 5 and to the spray nozzle 22. In the first position of the fluid valve 21, a fluid passage from the first cylinder orifice 5 to the spray nozzle 22 is provided. However, in a second position of the fluid valve 21 a fluid passage from the fluid reservoir 24 via a line 25 through the fluid valve 21 to the line 20 and finally to the first cylinder orifice 5 is provided. Thus, in the second position of the fluid valve 21, a fluid 26 which is located in the fluid reservoir 24 can be conveyed into the fluid chamber 3. The fluid 26 can in this case enter the fluid chamber 3 as a result of gravity or by means of a pump. However, in the present exemplary embodiment the fluid reservoir 24 is acted on with compressed air, which presses the fluid 26 into the fluid chamber 3. For this purpose, the fluid reservoir 24 is connected via a line 8 to a device 18 for the provision of compressed air. The device 18 may for example be a compressed air tank, a compressor and a hand pump. Furthermore, a shut-off valve 19 may optionally be arranged in the line 8.

Furthermore, the fluid reservoir 24 is connected via a line 27 to the first connection 7 of the compressed gas valve 17, which is also in the form of a 3/2-way valve. In the first position of this compressed gas valve 17, a compressed gas passage from the compressed air line 8 via the first connection 7 through the compressed gas valve 17 and the line 16 to the second cylinder orifice 6 into the pressure chamber 4 is provided. By contrast, in the second position of the compressed gas valve 17, this passage is closed and a compressed gas passage from the line 16 via a third connection 33 into the open is provided. Thus, in the second position, the pressure in the pressure chamber 4 can be reduced.

The fluid valve 21 and the compressed gas valve 17 may be electromagnetically actuable. They are connected to the control device 28, which can actuate them. In this case, as described above, the valves 17 and 21 can be changed over from the first position into the second position, and vice versa. For this purpose, the control device 28 may comprise for example a relay or a microprocessor.

Furthermore, the control device 28 is connected to a sensor 29. The sensor 29 may for example be in the form of a reed switch or comprise a reed contact. This contact is closed when the field strength of a magnetic field at the sensor 29 exceeds a limit value. The control device 28 detects whether the reed contact of the sensor 29 is closed or open.

The position of the piston 2 in the cylinder 1 can be detected by means of the sensor 29. In the spray gun according to the invention, a particular position of the piston 2 within the cylinder 1, in which position the expulsion operations are intended to be ended, is defined. The sensor 29 changes its state precisely in this defined position of the piston 2. This is detected by the control device 28. In order to bring about this change of state of the sensor 29, a permanent magnet 30 is integrated in the piston 2. This permanent magnet 30 generates a magnetic field, the field strength of which at the location of the sensor 29 depends on the position of the piston 2. If the piston 2 is in the defined position explained above, the magnetic field generated by the permanent magnet 30 causes a change of state in the sensor 29.

The filling of the fluid chamber 3 and the fluid expulsion in the second exemplary embodiment of the spray nozzle are explained in detail in the following text:

When the fluid chamber 3 is being filled with fluid, both the fluid valve 21 and the compressed gas valve 17 are in the second position. In this case, the fluid 26 in the fluid reservoir 24 is conveyed through the line 25 and through the fluid valve 21 via the line 20 into the fluid chamber 3 of the cylinder 1. The pressure exerted by the compressed air is in this case so high that the piston 2 is moved to the right in FIG. 2, specifically counter to the force which is exerted by the compression spring 13. During the movement of the piston 2, the air in the pressure chamber 4 escapes outward through the line 16, the compressed gas valve 17 and the third connection 33. The fluid chamber 3 can be filled with fluid, with the volume of the fluid chamber 3 increasing as a result of the movement of the piston 2, until the plate 12 of the piston 2 butts against the screw 14. When the piston 2 is at this stop, the maximum set volume of the fluid chamber 3 is reached and the fluid chamber 3 is completely filled with fluid.

If the trigger 31 is now actuated by a user, a corresponding signal is transmitted to the control device 28. The control device 28 thereupon switches the compressed gas valve 17 and the fluid valve 21 into the first position. In this position, the fluid supply from the fluid reservoir 24 is shut off, but the fluid passage from the fluid chamber 3 to the fluid valve 48 is open. Moreover, at the same time or preferably shortly beforehand, the compressed gas passage from the compressed air line 8 into the pressure chamber 4 is opened, so that compressed air is introduced into the pressure chamber 4.

As in the first exemplary embodiment, the control device 28 now regulates the pressure in the pressure chamber 4 such that it corresponds to the value which was determined during the calibration and is stored in the memory 54 in the control device 28. If the actual pressure measured corresponds to the stored setpoint pressure, the control device 28 uses a control signal to open the fluid valve 48 for a time interval, the length of which is stored in the memory 54 in the control device 28 and which was determined previously during the calibration. After the end of the time interval, the fluid valve 48 is closed again by means of the control device 28. For the length of the time interval, a fluid jet 23 was expelled during the expulsion operation.

In this way, a plurality of expulsion operations can now be carried out. In this case, the piston 2 moves in the direction of a reduction in the volume of the fluid chamber 3.

When the piston 2 now reaches the defined position explained above, the permanent magnet 30 generates at the sensor 29 a magnetic field having a field strength which leads to a change of state of the sensor 29. Such a change of state is detected by the control device 28, whereupon the control device 28, after the conclusion of the expulsion operation and after the closure of the fluid valve 48, switches the fluid valve 21 and the compressed gas valve 17 in each case back into the second position again. The changeover of the two valves 17 and 21 may take place simultaneously. Furthermore, it is possible for the fluid valve 21 to be changed over first, and only shortly thereafter the compressed gas valve 17.

Once the two valves 17 and 21 have been moved into the second position, the fluid chamber 3 is automatically filled with fluid again for the next expulsion operations, as explained above.

The third exemplary embodiment of the spray gun according to the invention is explained in the following text with reference to FIG. 3:

In the third exemplary embodiment, parts which have the same function as in the first and second exemplary embodiments are designated by the same reference signs. The function of these parts is also the same as in the first and/or second exemplary embodiment, and therefore the description of these parts is not repeated in detail.

The third exemplary embodiment of the spray gun differs from the second exemplary embodiment in particular in that the pressure chamber 4 of the second exemplary embodiment has been converted into a second fluid chamber 34. A first fluid chamber 3 and a second fluid chamber 34, which are separated from one another by the movable piston 2, are thus formed in the cylinder 1. Furthermore, the compression spring 13 of the second exemplary embodiment has been omitted.

As in the second exemplary embodiment, the first fluid chamber 3 is connected via the first cylinder orifice 5 and a line 20 to a fluid valve 21 which is designated as a first fluid valve 21 in this third exemplary embodiment. The first fluid valve 21, too, is in the form of a 3/2-way valve. As in the second exemplary embodiment, a connection of the first fluid valve 21 is connected to the spray nozzle 22. However, in the third exemplary embodiment a third fluid valve 35 is arranged between the connection of the first fluid valve 21 and the spray nozzle 22, as is explained later.

As in the second exemplary embodiment, the connection 32 of the first fluid valve 21 is connected to a fluid reservoir 24 in which fluid 26 is located. As in the second exemplary embodiment, the fluid reservoir 24 can be acted on with compressed air by means of the compressed air line 8, the shut-off valve 19 and the device 18 for the provision of compressed air. However, in all the exemplary embodiments, the fluid may also be put under pressure in another way, in order to move the piston 2, as explained later. For example, a pump may be used. In this case, there may also be provided a bypass, via which the fluid passes back into the reservoir when the cylinder 1 is not filled, because at least one fluid valve or a plurality of fluid valves is or are closed.

Unlike in the second exemplary embodiment, in the third exemplary embodiment the second cylinder orifice 6, which in this case is arranged at the second fluid chamber 34, is connected to a second fluid valve 36 via the line 16. This second fluid valve, too, is designed as a 3/2-way valve. The connection 37 of the second fluid valve 36 is connected to the fluid reservoir 24 via a line 38. The other connection 41 of the second fluid valve 36 is connected to the spray nozzle 22 via the third fluid valve 35.

The third fluid valve 35 is in the form of a 3/3-way valve with a shut-off middle position. A passage from the line 39 to the spray nozzle 22 or from the line 40 to the spray nozzle 22 can thus be produced. Furthermore, both passages may be shut off.

As in the second exemplary embodiment, a sensor 29 in the form of a reed switch is arranged in the first fluid chamber 3 and is designated as a first sensor 29 in the third exemplary embodiment. If the permanent magnet 30 of the piston 2 is in the defined position explained with regard to the second exemplary embodiment, this permanent magnet 30 generates a magnetic field, the field strength of which at the location of the first sensor 29 causes the reed contact to be closed. This is detected by the control device 29.

However, in the third exemplary embodiment, in contrast to the second exemplary embodiment, a corresponding second sensor 39 is located in the second fluid chamber 34. The second sensor 39, too, comprises a reed contact. In the spray gun of the third exemplary embodiment there is defined a further position of the piston 2, in which the expulsion operation is intended to be ended, specifically, in this case, the operation of expelling the fluid out of the second fluid chamber 34. The second sensor 39 is designed such that the reed contact is closed when the permanent magnet 30 of the piston 2 generates, in a correspondingly defined position, a magnetic field, the field strength of which at the location of the second sensor 39 exceeds the limit value for switching the reed contact. This change of state of the second sensor 39 is also detected by the control device 28.

Furthermore, the two sensors 29, 39 may be adjustable in the longitudinal direction of the cylinder 1. In this case, the fluid volume to be discharged can be adapted by the position of the sensors 29, 39 being changed.

Furthermore, the spray gun of the third exemplary embodiment, too, has a fluid valve 48 directly at the spray nozzle 22, said fluid valve 48 being electrically activatable by the control device 28. Furthermore, in each of the two fluid chambers 3 and 34 there is arranged a pressure sensor (not shown), which measures the pressure in each fluid chamber 3, 34 and transmits it to the control device 28.

The spraying operation with the spray gun according to the third exemplary embodiment is explained in the following text:

Before the actual spraying operation, the cylinder 1 of the spray gun is filled with fluid 26 from the fluid reservoir 24. In this initial state, the control device 28 first activates the third fluid valve 35 such that the passages in the direction of the spray nozzle 22 are shut off, that is to say the third fluid valve 35 is in the middle position. Furthermore, the fluid valve 48 is closed. Thereupon, the first fluid valve 21 is activated by the control device 28 such that a fluid passage from the fluid reservoir 24 into the first fluid chamber 3 is created. If the shut-off valve 19 is now opened, the fluid reservoir 24 is acted on with compressed air, so that fluid 26 flows via the line 25 through the first fluid valve 21 into the first fluid chamber 3. Alternatively, in this case, too, the fluid may be put under pressure, for example by means of a pump. Thus, in the illustration according to FIG. 3, the piston 2 is moved to the right until it butts against a stop (not illustrated). If, in this case, air is still located in the second fluid chamber 34, an outlet valve for displacing this air may be provided. If fluid 26 is already located in the second fluid chamber 34, the second fluid valve 36 is activated by the control device 28 such that the fluid passage between the line 38 and the line 16 is opened, so that the fluid in the second fluid chamber 34 can flow back into the reservoir 24.

If the trigger 31 is now actuated by a user, the control device 28 switches the first fluid valve 21 for a fluid passage from the line 20 into the line 39. The fluid passage from the line 20 into the line 25 is shut off. By contrast, the second fluid valve 36 is switched such that the fluid passage from the line 38 into the line 16 is opened, but the fluid passage from the line 16 into the line 40 is shut off. Furthermore, the control device 28 activates the third fluid valve 35 such that the fluid passage from the line 39 to the fluid valve 48 is opened, but the fluid passage from the line 40 to the fluid valve 48 is shut off. This switching of the three fluid valves 21, 36 and 35 has the effect that, by the fluid reservoir 24 being acted on with compressed air, fluid 26 flows via the line 38 through the second fluid valve 36 into the second fluid chamber 34. The fluid in the second fluid chamber 34 exerts a force on the piston 2 so that the latter is pressed in the direction of a reduction in the volume of the first fluid chamber 3, to the left in the illustration according to FIG. 3. The fluid located in the first fluid chamber 3 is thus pressed through the first cylinder orifice 5 via the line 20, through the first fluid valve 21 via the line 39 and through the third fluid valve 35 to the fluid valve 48.

If, as in the first two exemplary embodiments, the pressure exerted on the fluid now corresponds to the setpoint value stored in the control device 28, the control device 28 opens the fluid valve 48 for the previously set time interval, the length of which is stored in the memory 54 in the control device 28, and the fluid is expelled as a fluid jet 23. Such an expulsion operation can be repeated until the magnetic field generated by the permanent magnet 30, at the location of the first sensor 29, exceeds a field strength which brings about a change of state of the first sensor 29, said change of state being detected by the control device 28. As soon as this change of state has been detected, the control device 28 changes over the three fluid valves 21, 36 and 35, after the conclusion of the last expulsion operation, as follows: the first fluid valve 21 is switched such that the passage from the line 20 to the line 39 is shut off, but the passage from the line 25 to the line 20 is opened. The second fluid valve 36 is changed over such that the fluid passage from the line 38 into the line 16 is shut off, but the fluid passage from the line 16 into the line 40 is opened. Furthermore, the third fluid valve 35 is changed over such that it is moved into the completely shutting-off middle position or such that it is moved directly into a position in which the fluid passage from the line 40 to the spray nozzle 22 is opened, but the fluid passage from the line 39 to the spray nozzle 22 is shut off. When the defined position of the piston 2 has been detected, at least the first fluid valve 21 or the third fluid valve 35 for the passage from the first fluid chamber 3 to the spray nozzle 22 is shut off.

This changing over of the three fluid valves 21, 36, 35 has the effect that the fluid 26 now flows the other way round under pressure via the line 25, through the first fluid valve 21 into the first fluid chamber 3. Here, the fluid exerts a force upon the piston 2 so that the latter is moved in the direction of a reduction in the volume of the second fluid chamber 34, to the right in the illustration according to FIG. 3. The first fluid chamber 3 is now filled. However, as a result of this filling, the fluid located in the second fluid chamber 34 is pressed via the line 16, through the second fluid valve 36, via the line 40, through the third fluid valve 35, to the fluid valve 48.

A series of expulsion operations of the fluid located in the fluid chamber 34 can now again take place. These expulsion operations last until the magnetic field generated by the permanent magnet 30 at the location of the second sensor 39 reaches a field strength which causes a change of state of the second sensor 39. As soon as such a change of state has been detected by the control device 28, after the conclusion of the last expulsion operation, the fluid valves 21, 36 and 35 are switched back again, as explained above, so that subsequently the second fluid chamber 34 is filled.

The fluid is expelled from the spray gun of the third exemplary embodiment, as in the spray gun of the first or second exemplary embodiment, as a fluid jet 23 which has a constant expulsion velocity up to the end of the expulsion operation, so that the fluid jet 23 reaches its target completely. Moreover, the fluid valve 48 prevents fluid from dripping.

The fourth exemplary embodiment of the spray gun according to the invention is explained in the following text with reference to FIG. 4:

In the fourth exemplary embodiment, parts which have the same function as in the preceding exemplary embodiments are designated by the same reference signs. The function of these parts is also the same as in the preceding exemplary embodiments, and therefore the description of these parts is not repeated in detail.

The basic functioning of the spray gun of the fourth exemplary embodiment corresponds to the spray gun of the third exemplary embodiment. However, in this case a single cylinder 1 comprising two fluid chambers 3 and 34 which are separated by the piston 2 is not provided, but rather two cylinders 1-1 and 1-2 are provided. However, the functional principle corresponds substantially to the functional principle of the spray gun of the third exemplary embodiment.

A first fluid chamber 3-1 having a first cylinder orifice 5-1 is formed in the first cylinder 1-1. Furthermore, a first pressure chamber 4-1 is formed in the first cylinder 1-1. A movable first piston 2-1 is arranged between the first fluid chamber 3-1 and the first pressure chamber 4-1.

Correspondingly, a second fluid chamber 3-2 with a second cylinder orifice 5-2 is formed in the second cylinder 1-2. A second pressure chamber 4-2 is formed in the second cylinder 1-2, too, a movable second piston 2-2 being arranged between the second fluid chamber 3-2 and the second pressure chamber 4-2. The first pressure chamber 4-1 and the second pressure chamber 4-2 communicate with one another via a line 42. A non-compressible working fluid, such as oil, for example, is located in the first and the second pressure chamber 4-1, 4-2 and the line 42. Furthermore, the line 42 may be connected to a reservoir 43 for the working fluid. The volume of the working fluid in the two pressure chambers 4-1, 4-2 and the line 42 can be varied via the reservoir 43. The maximum volume of the two fluid chambers 3-1, 3-2 and consequently the expelled fluid volume can be set in this way.

Alternatively or in addition, as in the spray gun of the third exemplary embodiment, the two sensors 29-1, 29-2 may be adjustable in the longitudinal direction of the cylinder 1-1, 1-2, so that the fluid volume to be discharged can be adapted by the position of the sensors 29-1, 29-2 being varied.

The working fluid transmits a force exerted by the first piston 2-1 to the second piston 2-2, and vice versa. The unit formed from the first piston 2-1, the working fluid and the second piston 2-2 thus corresponds to the piston 2 of the spray gun of the third exemplary embodiment.

The spray gun of the fourth exemplary embodiment comprises two fluid valves 44 and 45. The fluid valve 44 is also designated as first fluid valve 44 in the following text. Since the fluid valve 45 corresponds functionally to the third fluid valve 35 of the third exemplary embodiment, this fluid valve 45 is also designated as third fluid valve 45 in the following text.

The first cylinder orifice 5-1 of the first fluid chamber 3-1 is connected via a line 46 to a connection of the first fluid valve 44 and of the third fluid valve 45. Furthermore, the second cylinder orifice 5-2 of the second fluid chamber 3-2 is connected via a line 47 to another connection of the first fluid valve 44 and to another connection of the third fluid valve 45. A further connection of the first fluid valve 44 is coupled via a line 25 to the fluid reservoir 24 in which the fluid 26 is located. As in the first exemplary embodiments, the fluid reservoir 24 is coupled via a compressed air line 8 and an optional shut-off valve 19 to a device 18 for the provision of compressed air. However, it would also be possible to put the fluid under pressure directly, for example by means of a pump. The first fluid valve 44 is activated by the control device 28. In one state of the first fluid valve 44, a passage from the line 25 to the line 46 is provided, the passage from the line 25 to the line 47 being shut off. In the other state, a passage from the line 25 to the line 47 is provided, the passage from the line 25 to the line 46 being shut off.

The spray gun of the fourth exemplary embodiment, too, has a fluid valve 48 directly at the spray nozzle 22, said fluid valve 48 being electrically controlled by means of the control device 28. Furthermore, pressure sensors (not shown), which are coupled to the control device 28 are provided at the pressure chambers 4-1 and 4-2.

The third fluid valve 45 is activated by the control device 28, with in one state a passage from the line 46 to the fluid valve 48 being opened, whereas the passage from the line 47 to the fluid valve 48 is shut off. In another state, the passage from the line 46 to the fluid valve 48 is shut off, whereas the passage from the line 47 to the fluid valve 48 is opened. Furthermore, as in the spray gun of the third exemplary embodiment, there is provided a middle position, in which both passages to the fluid valve 48 are shut off.

Similarly to the spray guns of the preceding exemplary embodiments, a first sensor 29-1 is provided for the first cylinder 1-1 in the first fluid chamber 3-1 and detects the position of the first piston 2-1 on account of a magnetic field generated by a first permanent magnet 30-1. Likewise, a second sensor 29-2 is provided in the second fluid chamber 3-2 of the second piston 1-2 and detects the position of the second piston 2-2, in that, as explained with regard to the third exemplary embodiment, a change of state of the second sensor 29-2 is detected by means of the field strength of a magnetic field generated by a second permanent magnet 30-2 which is arranged at the second piston 2-2. As in the spray gun of the third exemplary embodiment, the signals of the two sensors 29-1 and 29-2 are transmitted to the control device 28, which activates the two fluid valves 44 and 45 depending on these signals.

A spraying operation which is carried out by the spray gun of the fourth exemplary embodiment is explained in the following text:

As in the preceding exemplary embodiments, fluid expulsion is initiated in that a user actuates the trigger 31, which is connected to the control device 28.

First of all, the control device 28 activates the first fluid valve 44 such that a fluid passage from the line 25 to the line 46 is provided, so that the first fluid chamber 3-1 can be filled with fluid 26. The third fluid valve 45 is first of all located in the middle position in which the two passages are shut off. The first fluid chamber 3-1 is filled with fluid, as a result of which the piston 2-1 is moved to the right in the illustration according to FIG. 4, so that the volume of the first fluid chamber 3-1 increases. At the same time, on account of the transmission of force by the working fluid, the second piston 2-2 moves to the left in the illustration according to FIG. 4, in the direction of a reduction in the volume of the second fluid chamber 3-2. If air is still located in the second fluid chamber 3-2 when the spray gun is put into operation, an outlet valve (not shown) may be provided for this air. The first piston 2-1 is moved in the direction of an increase in the volume of the first fluid chamber 3-1 until the first piston 2-1 butts against a stop which may be provided by a cylinder wall or, as in the spray gun of the second exemplary embodiment, by an adjusting screw. The control device 28 subsequently changes over the first fluid valve 44 such that a fluid passage from the line 25 into the line 47 is provided. Furthermore, the third fluid valve 45 is switched such that a fluid passage from the line 46 to the spray nozzle 22 is opened.

By the action of pressure on the fluid reservoir 24, the fluid 26 is now pressed through the first fluid valve 44 and the line 47 into the second fluid chamber 3-2. Alternatively, as in the spray gun of the third exemplary embodiment, the fluid may also be put under pressure, for example, by means of a pump. As a result, the second piston 2-2 is moved in the direction of an increase in the volume of the second fluid chamber 3-2. At the same time, on account of the communication between the two pressure chambers 4-1 and 4-2, the first piston 2-1 is moved in the direction of a reduction in the volume of the first fluid chamber 3-1, as a result of which fluid is pressed out of the first fluid chamber 3-1 via the line 46, through the third fluid valve 45 to the fluid valve 48.

Now, as in the second and the third exemplary embodiment, the fluid valve 48 can be opened for the previously set time interval defined during the calibration, in order to expel the fluid as a fluid jet 23. The expulsion operations can be repeated until the first piston 2-1 has reached the defined position, this being sensed by the first sensor 29-1, as explained above. Following the conclusion of the last expulsion operation, the control device 28 then switches the third fluid valve 45 in such a way that the fluid passage from the line 46 to the fluid valve 48 is shut off. The third fluid valve 45 is in this case moved in particular into the completely shutting-off middle position. Thereupon, the first fluid valve 44 is changed over, so that a fluid passage from the line 25 to the line 46 is opened. The third fluid valve 45 is now moved into a position in which a passage from the line 47 to the fluid valve 48 is provided. By the action of pressure on the fluid reservoir 24, fluid 26 is now pressed through the first fluid valve 44 and the line 46 into the first fluid chamber 3-1. As a result, the first piston 2-1 is moved in the direction of an increase in the volume of the first fluid chamber 3-1. At the same time, the second piston 2-2 is moved in the direction of a reduction in the volume of the second fluid chamber 3-2, as a result of which the fluid located in the second fluid chamber 3-2 is pressed through the line 47 and through the third fluid valve 45 to the fluid valve 48. Subsequently, a new series of expulsion operations can begin.

In the above-described four exemplary embodiments, it is furthermore possible not to use a memory 54. Instead, the pressure exerted on the fluid in the fluid chamber 3, said pressure having previously been set, can be adjusted or regulated mechanically by means of a pressure valve, by means of a pump, for example via the regulation of the rotational speed of the pump, or by means of other techniques which are known per se.

A fifth exemplary embodiment of the spray gun according to the invention is explained in the following text with reference to FIG. 5:

In the fifth exemplary embodiment, parts which have the same function as in the preceding exemplary embodiments are designated by the same reference signs. The function of these parts is also the same as in the preceding exemplary embodiments, and therefore the description of these parts is not repeated in detail.

The fifth exemplary embodiment is similar to the first exemplary embodiment. However, in this case the fluid chamber 3 is not formed by a cylinder but by a line, which, as shown in FIG. 5, is immersed in the fluid located in the fluid reservoir 51. The fluid is located at the bottom of the fluid reservoir 51 and an air reservoir which is closed off in a gas-tight manner is located above the surface of the fluid. This air reservoir is connected to a pressure chamber 4 via a pressure line 58. The pressure chamber 4 is connected in turn, as in the first exemplary embodiment, to a compressed air cylinder 18 via a line 16 and a compressed gas valve 17. The compressed gas valve 17 is controlled by the control device 28 such that a constant previously set pressure is exerted on the fluid located in the fluid reservoir 51. This ensures that a pressurized fluid is always located in the fluid chamber 3 which is in the form of a line.

As in the first exemplary embodiment, the fluid valve 48, which is activated via the control device 28, is provided directly upstream of the spray nozzle 22. Provided in this case in the control device 28 is a timer, which determines the opening time of the fluid valve 48 during the expulsion of the fluid jet 23. As in the first exemplary embodiment, following the actuation of the trigger 31 by means of the control device 28 the fluid valve 28 is opened for a previously set time interval and a defined volume or a defined weight of the fluid is expelled through the spray nozzle 22.

A sixth exemplary embodiment of the spray gun according to the invention is explained in the following text with reference to FIG. 6:

In the sixth exemplary embodiment, parts which have the same function as in the preceding exemplary embodiments are designated by the same reference signs. The function of these parts is also the same as in the preceding exemplary embodiments, and therefore the description of these parts is not repeated in detail.

The structure of the sixth exemplary embodiment of the spray gun is similar to the structure of the fifth exemplary embodiment of the spray gun. However, in this case a fluid pump 56 is arranged between the fluid chamber 3 in the form of a line and the fluid reservoir 51. A device for the provision of compressed air is not required in this case.

That end of the fluid chamber 3 which is remote from the fluid valve 48 is adjoined by the fluid pump 56, which is connected to the fluid reservoir 51 via the line 57. By means of the fluid pump 56, the fluid located in the fluid reservoir 51 is pumped out and pumped into the fluid chamber 3. Furthermore, there may be provided a bypass, via which the fluid can pass back into the fluid reservoir 51 if the pressure exerted on the fluid is too high. The fluid pump 56 is electrically coupled to the control device 28 so that it can be activated by the control device 28. Activation takes place such that a constant pressure is always exerted on the fluid located in the fluid chamber 3. For this purpose, for example the rotational speed of the fluid pump can be regulated.

The expulsion operation then takes place in the same manner as in the fifth exemplary embodiment.

The spray guns of the second to sixth exemplary embodiments and the methods implemented by these spray guns are carried out in particular with the plant protection compositions which were mentioned initially and with reference to the first exemplary embodiment.

In the above-described exemplary embodiments, the fluid valve 48 is arranged directly at the spray orifice 22. In a further, seventh exemplary embodiment, experiments were carried out to study what effect the distance of the fluid valve 48 from the spray orifice 22 has on the dripping behavior at the nozzle when fluids having different viscosities are expelled.

The structure of the seventh exemplary embodiment corresponds to the structure of the first exemplary embodiment, apart from the distance of the fluid valve 48 from the spray orifice 22.

The fluid valve 48 was connected to the spray nozzle 22 via a flexible tube. The outside diameter of the flexible tube was 8 mm and the inside diameter was 6 mm. A Lechler 544.320 full-jet nozzle was used as the nozzle.

The spray nozzle 22, in which the spray orifice is formed, was positioned 10 cm over an application area, which takes up a path length of 120 cm. In addition, the spray nozzle 22 was oriented such that the application jet likewise projects 10 cm beyond the application area at the end of the path. In order to measure the loss of fluid during the expulsion operation on the application area, previously tared paper was laid out. The test was then carried out as follows: after a fluid reservoir had been filled, the system was conditioned with the substance to be tested, i.e. a fluid having a particular viscosity was filled into the fluid reservoir. Next, in order to avoid errors, the spray nozzle 22 was dabbed dry directly prior to the first application. Each part of the test consists of three applications, which were carried out at a spraying pressure of 3 bar. Each application lasted 1.5 seconds. In order to allow for possible dripping, 8.5 seconds were waited between each discharge. At the end, the residual fluid from the spray nozzle 22 was absorbed using the paper and weighed.

The test results are given in the following table:

| Starting material | | | | | Amount | | |
|---|---|---|---|---|---|---|---|
| BAS | | | | | from 3 | | |
| 310 | | | Flexible tube | | applications | Observations | |
| 63 I | Water | Viscosity | Type | Length | [g] | Application route | Nozzle mouth |
| 1 | 3 | 123.8 mPa · s | Festo 8 | 0 cm | 0.03 | localized very | No dripping at |
| | | | | | | small droplets on | the nozzle |
| | | | | | | the path | |
| 1 | 2 | 215.2 mPa · s | Festo 8 | 0 cm | 0.00 | localized very | No dripping at |
| | | | | | | small droplets on | the nozzle |
| | | | | | | the path | |
| 1 | 1 | 579.0 mPa · s | Festo 8 | 0 cm | 0.01 | localized very | No dripping at |
| | | | | | | small droplets on | the nozzle |
| | | | | | | the path | |
| 1 | 3 | 123.8 mPa · s | Festo 8 | 50 cm | 0.17 | Some drops | Drips a little |
| | | | | | | discernible | |
| 1 | 2 | 215.2 mPa · s | Festo 8 | 50 cm | 0.23 | Some drops | Drips a little |
| | | | | | | discernible | |
| 1 | 1 | 579.0 mPa · s | Festo 8 | 50 cm | 0.45 | Some drops | Drips a little |
| | | | | | | discernible | |
| 1 | 3 | 123.8 mPa · s | Festo 8 | 100 cm | 0.34 | Increased | Drips at the |
| | | | | | | number of drops | nozzle |
| | | | | | | seen on the path | |
| 1 | 2 | 215.2 mPa · s | Festo 8 | 100 cm | 0.41 | Increased | Drips at the |
| | | | | | | number of drops | nozzle |
| | | | | | | seen on the path | |
| 1 | 1 | 579.0 mPa · s | Festo 8 | 100 cm | 0.60 | Increased | Drips at the |
| | | | | | | number of drops | nozzle |
| | | | | | | seen on the path | |

FIG. 7 illustrates the relationship of the fluid loss depending on the mixing ratio between the active substance and water, i.e. the viscosity of the fluid, and the distance between the spray nozzle 22 and the fluid valve 28.

It has been found in tests that the application time has no effect on the fluid loss, since, as soon as the spray jet has been built up, no drops deviate from the target. However, when the spray jet is being built up and particularly when it is being broken down, drops could be registered on the application path. In addition, there is dripping at the nozzle opening. The results of the tests show greater loss with an increasing “dead volume” between the valve 48 and the spray nozzle 22, i.e. with a greater distance between the valve 48 and the spray nozzle 22. In particular at a distance of more than 50 cm, an undesired fluid loss arises. In this case, the loss is greater on the application route, the greater the viscosity of the fluid, i.e. the spray liquor, is. The consistency of the formulation thus also has a great influence on the fluid loss. A possible explanation for this is that the more viscous fluid absorbs more energy, which has to be released again after the fluid valve 48 is closed. This results in dripping. A further indication therefor was a required steeper incidence angle of the spray nozzle 22 for more viscous fluids. This steeper incidence angle was required in order to reach the target.

In preliminary tests, it was moreover found that tapering of the flexible tube between the spray nozzle 22 and the fluid valve 48 results in smaller losses. An increase in the pressure results in an increased fluid loss on the path from the spray nozzle 22 to the target. However, fluid losses can be largely ruled out when a “dead volume” from the fluid valve 48 to the spray nozzle 22 is avoided, i.e. when the spray nozzle 22 is arranged directly at the fluid valve 48.

### LIST OF REFERENCE SIGNS

1 Cylinder
1-1 First cylinder
1-2 Second cylinder
2 Piston
3 Fluid chamber; first fluid chamber
3-1 First fluid chamber
3-2 Second fluid chamber
4 Pressure chamber
4-1 First pressure chamber
4-2 Second pressure chamber
5 Cylinder orifice, first cylinder orifice
5-1 First cylinder orifice
5-2 Second cylinder orifice
6 Cylinder orifice, second cylinder orifice
7 First connection
8 Compressed air line
9 Shank of piston 2
10 Bearing
11 Cylinder
12 Plate
13 Compression spring
14 Screw
15 Terminating wall
16 Line
17 Compressed gas valve
18 Device for the provision of compressed air, compressed air cylinder
19 Shut-off valve
20 Line
21 Fluid valve; first fluid valve
22 Spray nozzle
23 Fluid jet
24 Fluid reservoir
25 Line
26 Fluid
27 Line
28 Control device
29 Sensor; first sensor
30 Permanent magnet
31 Trigger
32 Second connection
33 Third connection
34 Second fluid chamber
35 Third fluid valve
36 Second fluid valve
37 Connection
38 Line
39 Line
40 Line
41 Connection
42 Line
43 Reservoir
44 Fluid valve; first fluid valve
45 Fluid valve; third fluid valve
46 Line
47 Line
48 Fluid valve
49 Fluid valve
50 Fluid line
51 Fluid reservoir
52 Pressure sensor
53 Cylinder orifice
54 Memory
55 Timer
56 Fluid pump
57 Line
58 Compressed gas line

1-18. (canceled)

19. A method for the expulsion of a plant protection composition by means of a fluid chamber (3) which communicates with a spray orifice (22) via an electrically activatable fluid valve (48), the method comprising
setting a pressure and a length of a time interval for the expulsion of the plant protection composition,
filling the plant protection composition into the fluid chamber (3),
exerting the previously set pressure on the plant protection composition located in the fluid chamber (3), and
opening the fluid valve (48) for the previously set time interval by means of an electric control signal and closing the fluid valve (48) after the end of the time interval so that a defined volume or a defined weight of the plant protection composition is expelled through the spray orifice (22).

20. The method according to claim 19, wherein the pressure which is exerted on the plant protection composition located in the fluid chamber (3) is kept constant during the time interval in which the fluid valve (48) is open.

21. The method according to claim 19, wherein the pressure exerted on the plant protection composition located in the fluid chamber (3) is generated by means of a pressurized gas or a pump.

22. The method according to claim 19, wherein the distance between the fluid valve (48) and the spray orifice (22) is less than 50 cm.

23. The method according to claim 19, wherein the fluid valve (48) is arranged directly at the spray orifice (22).

24. The method according to claim 19, wherein the plant protection composition is a gel-like fluid which has at 25° C. a dynamic viscosity which is determined by Brookfield's rotational viscometry with a shear gradient of 100 s⁻¹ and is in the range of from 30 to 1000 mPa·s.

25. The method according to claim 19, wherein the rheological properties of the plant protection composition change within a temperature range of from 15° C. to 35° C. only such that the quantity expelled per unit time at a given pressure at a particular spray orifice (22) fluctuates only in a range of +/−10%.

26. The method according to claim 19, wherein the length of the time interval is set by a previously carried out calibration in which the dependence of the expelled volume or weight of a plant protection composition of a particular viscosity on the exerted pressure and the length of the time interval is determined.

27. A spray gun for the expulsion of a fluid having
a fluid chamber (3),
a spray orifice (22) which communicates with the fluid chamber (3), and
a pressure device (1, 2, 4, 16, 17, 18, 56) which is coupled to the fluid chamber (3) and by means of which a pressure can be exerted on the fluid located in the fluid chamber (3),
wherein
an electrically activatable fluid valve (48) for opening and closing the passage from the fluid chamber (3) to the spray orifice (22) is arranged at the spray orifice (22) and
the fluid valve (48) is data-coupled to an electric control device (28) by way of which an electric control signal for opening the fluid valve (48) for a particular previously set time interval and for closing the fluid valve (48) after the end of the time interval can be generated so that a defined volume or a defined weight of the fluid is expelled via the spray orifice (22).

28. The spray gun according to claim 27, wherein said fluid is a plant protection composition.

29. The spray gun according to claim 27, wherein the control device (28) comprises a memory (54) for storing a previously set pressure and the previously set length of the time interval.

30. The spray gun according to claim 27, wherein the pressure device (1, 2, 4, 16, 17, 18, 56) comprises a fluid pump (56), by means of which the pressure can be exerted on the fluid located in the fluid chamber (3).

31. The spray gun according to claim 27, wherein the pressure device (1, 2, 4, 16, 17, 18, 56) comprises a compressed gas line (16) which is coupled to the fluid chamber (3) for exerting the pressure on the fluid located in the fluid chamber (3).

32. The spray gun according to claim 27, wherein the fluid chamber (3) and the spray orifice (22) are connected together via a connecting line (20), and wherein the fluid valve (48) is arranged adjacent to the spray orifice (22) in the connecting line (20).

33. The spray gun according to claim 27, wherein the distance between the fluid valve (48) and the spray orifice (22) is less than 50 cm.

34. The spray gun according to claim 27, wherein the fluid valve (48) is arranged directly at the spray orifice (22).

35. The spray gun according to claim 27, wherein the spray gun is configured for a gel-like plant protection composition and the spray orifice is surrounded by a spray nozzle (22) which generates a jet (23) when the gel-like plant protection composition passes through.
